(19) United States
(12) Patent Application Publication
(10) Pub. No.: US 2014/0350909 A1
(43) Pub. Date: Nov. 27, 2014

(54) SIMULATION TESTING SYSTEM FOR POWER CONSUMPTION OF ELECTRONIC DEVICE

(71) Applicants: Hon Hai Precision Industry Co., Ltd., New Taipei (TW); Hong Fu Jin Precision Industry (ShenZhen) Co., Ltd., Shenzhen (CN)

(72) Inventor: KANG-BIN WANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/133,918

(22) Filed: Dec. 19, 2013

(30) Foreign Application Priority Data
May 23, 2013 (CN) 2013101962663

(51) Int. Cl. G06F 17/50

(52) U.S. Cl. CPC G06F 17/5009
USPC 703/14

(57) ABSTRACT

A simulation testing system is used to test power consumption of an electronic device including a plurality of electronic components. The simulation testing system includes a power supply unit, a main controller connected to the power supply unit, and a simulation system comprising a plurality of heating resistors arranged in a matrix. Each of plurality of heating resistor is connected to the power supply unit via a switch controlled by the main controller. The main controller turns on a number of the switches to power on the number of the plurality of heating resistors and to simulate a plurality of electronic components of the electronic device.

### BACKGROUND

1. Technical Field

The disclosure generally relates to a testing system, and more particularly to a simulation testing system for testing power consumption of an electronic device.

2. Description of Related Art

Greater efficiency of energy usage is a desirable feature of may electronic devices, such as computers, or servers, that consume a great deal of energy. It is important to improve energy consumption of computers, especially for desktop computers. Therefore, when designing an electronic device, a power consumption status of the electronic device are tested. In conventional methods, a sample electronic device needs to be developed to undergo such a test, which may be expensive.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of one embodiment of a simulation testing system for testing power consumption of an electronic device.

FIG. 2 is a sketch view of a switch of the simulation testing system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

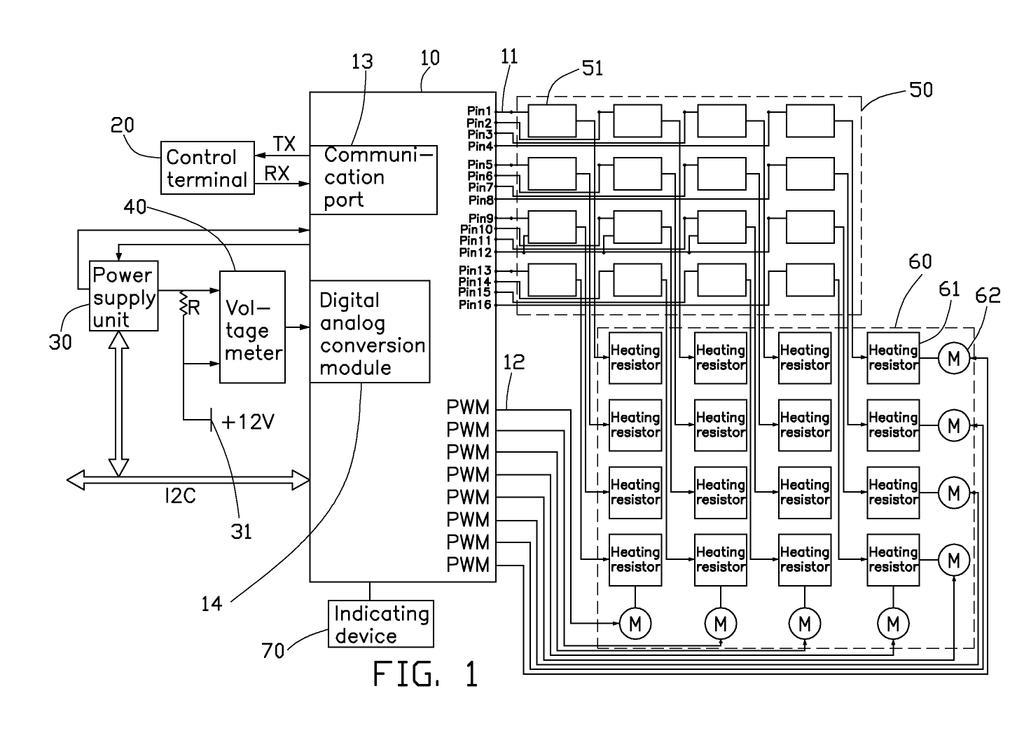

FIG. 1 shows one embodiment of a simulation testing system for testing power consumption of an electronic device. The simulation testing system includes a main controller 10, a control terminal 20, a power supply unit 30, a voltage meter 40, a control circuit 50, a simulation system 60, and an indicating device 70.

The simulation system 60 can simulate an electronic device which is needed to be tested. The simulation system 60 includes a plurality of heating resistors 61, which are laid in a matrix. In one embodiment, the plurality of heating resistors 61 is laid in four rows and four columns. These heating resistors 61 are used to simulate electronic components of the electronic devices. For example, there is one electronic component located at row 2 and column 2. The heating resistor 61 at the corresponding position (row 2 and column 2) is set to have a same power as the electronic component and is turned on to generate heat. The simulation system 60 further includes a plurality of fans 62. Each row and each column of the matrix equips a fan 62.

The power supply unit 30 includes an output end 31. In one embodiment the output end 31 outputs a +12V power.

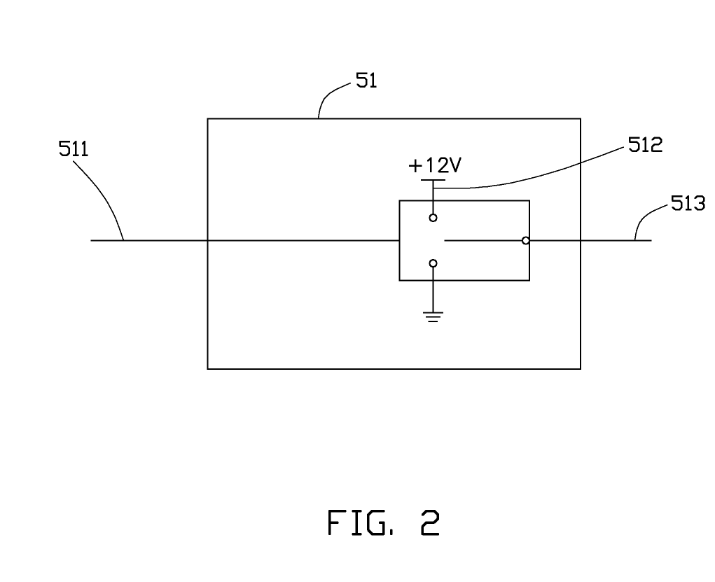

FIGS. 1 and 2 show that the control circuit 50 includes a plurality of switches 51. Each switch 51 includes a control end 511, a first connection end 512, and a third connection end 513. When the control end 511 receives a high level voltage signal, the first connection end 512 and the third connection end 513 are connected. When the control end 511 receives a low level voltage signal, the first connection end 512 and the third connection end 513 are disconnected. The third connection end 513 of each switch 51 is connected to a heating resistor 61. The first connection end 512 of each switch 51 is connected to the output end 31.

The main controller 10 includes a plurality of switch control pins 11, a plurality of pulse signal output pins 12, a communication port 13, and a digital analog conversion module 14. Each switch control pin 11 is connected to the control end 511 of one corresponding switch 51 to turn on or off the corresponding switch 51. Each plug signal output pin 12 is connected to a corresponding fan 62 to provide power to the corresponding fan 62. The communication port 13 is connected to the control terminal 20.

A resistor R is connected on the output end 31. In one illustrated embodiment, the resistor R has a small resistance, such as 0.001 ohm. A voltage meter 40 is parallel connected to the resistor R to measure a voltage on the resistor R. The digital analog conversion module 14 is connected to the voltage meter 40 and reads the voltage on the resistor R. The voltage on the resistor R is converted in a digital data by the digital analog conversion module 14. A current flowing through the resistor R can be calculated based on the voltage on the resistor R and the resistance of the resistor R.

The main controller 10 is connected to the power supply unit 30 via a inter-integrated circuit bus to turn on or off the power supply unit 30.

At work, the power supply unit 30 is powered on by the main controller 10. The output end 31 provides the +12V power. According to a layout of electronic components located in the electronic device, the control terminal 20 inputs a simulation control signal to the main controller 10 to turn on corresponding heating resistors 12 and fans 62 to simulate the electronic components located in the electronic device. The voltage meter 40 measures voltage on the resistor R. The main controller 10 calculates a current flowing through the resistor R based on the voltage on the resistor R and the resistance of the resistor R. The current flowing through the resistor R is equal to a current flowing through the output end 31. Therefore, a current output power of the power supply unit 30 can be calculated based on the current flowing through the output end 31 and the output voltage on the output end 31. If the current output power of the power supply unit 30 is larger than a rated output power of the power supply unit 30, the indicating device 70 lights a red light. If the current output power of the power supply unit 30 is equal to or less than a rated output power of the power supply unit 30, the indicating device 70 lights a green light.

In the above simulation testing system, the simulation system 60 simulates a power consumption of the electronic device to test whether the power supply unit 30 is proper for the electronic device.

Although numerous characteristics and advantages have been set forth in the foregoing description of embodiments, together with details of the structures and functions of the embodiments, the disclosure is illustrative only, and changes can be made in detail, especially in the matters of arrangement of parts within the principles of the disclosure to the full extent indicated by the broad general meaning of the terms in which the appended claims are expressed.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

What is claimed is:

1. A simulation testing system configured for testing power consumption, the simulation testing system comprising:
a power supply unit;
a main controller connected to the power supply unit; and
a simulation system comprising a plurality of heating resistors, arranged in a matrix, each of plurality of heating resistor being connected to the power supply unit via a switch which is controlled by the main controller; wherein the main controller is configured to turn on a number of the switches to power on the number of the plurality of heating resistors and to simulate a plurality of electronic components of an electronic device.

2. The simulation testing system of claim 1, wherein each of the switch comprises a control end, a first connection end, and a second connection end, the main controller comprises a plurality of switch control pins, each of the switch control pins is connected to the control end of the switch, the first connection end of the switch is connected to the power supply unit, and the second end of the switch is connected to a corresponding heating resistor of the plurality of heating resistors.

3. The simulation testing system of claim 1, wherein the main controller comprises a plurality of pulse signal output pins, the simulation system comprises a plurality of fans, and each of the pulse signal output pins is connected to and provide electric power to each of the plurality of fans.

4. The simulation testing system of claim 1, wherein the power supply unit comprises an output end, a resistor is connected on the output end, and a voltage meter is parallel connected to the resistor.

5. The simulation testing system of claim 4, wherein the main controller comprises a digital analog conversion module which is connected to the voltage meter.

6. The simulation testing system of claim 1, wherein an indicating device is connected to the main controller, and the indicating device is configured to indicate whether a current output power of the power supply unit is larger than a rated output power.

7. The simulation testing system of claim 1, wherein the main controller comprises a communication port which is connected to a control terminal.

8. The simulation testing system of claim 1, wherein main controller is connected to the power supply unit via an inter-integrated circuit bus to turn on or off the power supply unit.

9. A simulation testing system configured for testing power consumption, the simulation testing system comprising:
a simulation system comprising a plurality of heating resistors correspondingly arranged as electronic components arranged in an electronic device, and corresponding heating resistor and electronic component, which have a same position, having a same power;
a power supply unit connected to the plurality of heating resistors and configured to provide power to the plurality of heating resistors; and
a main controller connected to the power supply unit and configured to measure a current output power of the power supply unit.

10. The simulation testing system of claim 9, wherein the power supply unit is connected to each of the plurality of heating resistor via a switch which is controlled by the main controller

11. The simulation testing system of claim 10, wherein each of the switch comprises a control end, a first connection end, and a second connection end, the main controller comprises a plurality of switch control pins, each of the switch control pin is connected to the control end of each of the switch, the first connection end of each of the switch is connected to the power supply unit, and the second end of each of the switch is connected to a corresponding heating resistor of the plurality of heating resistors.

12. The simulation testing system of claim 9, wherein the main controller comprises a plurality of pulse signal output pins, the simulation system comprises a plurality of fans, and each of the pulse signal output pins is connected and provide electric power to each of the plurality of fans.

13. The simulation testing system of claim 9, wherein the power supply unit comprises an output end, a resistor is connected on the output end, and a voltage meter is parallel connected to the resistor.

14. The simulation testing system of claim 13, wherein the main controller comprises a digital analog conversion module which is connected to the voltage meter.

15. The simulation testing system of claim 9, wherein an indicating device is connected to the main controller, and the indicating device is configured to indicate whether a current output power of the power supply unit is larger than a rated output power.

16. The simulation testing system of claim 9, wherein the main controller comprises a communication port which is connected to a control terminal.

17. The simulation testing system of claim 9, wherein main controller is connected to the power supply unit via an inter-integrated circuit bus to turn on or off the power supply unit.
